(19) United States
(12) Patent Application Publication
(10) Pub. No.: US 2002/0116570 A1
(43) Pub. Date: Aug. 22, 2002

(54) Microcomputer

(76) Inventor: Taiyuu Miyamoto, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/998,830

(22) Filed: Dec. 3, 2001

(30) Foreign Application Priority Data
Feb. 16, 2001 (JP) 2001-40747

(51) Int. Cl. G06F 12/14

(52) U.S. Cl. 711/103; 711/163; 711/202

(57) ABSTRACT

A microcomputer having a data EEPROM and a program EEPROM, in which a predetermined lock code is written a the specific area, comprising a lock-code-decoding circuit that is connected with the data EEPROM, reads out the concerned lock code, and decodes the code; a logic circuit that performs a predetermined operation on a mode bit that was serially input from the outside, by the output of the lock-code-decoding circuit; and a mode-bit-decoding circuit that decodes the processed mode bit by receiving the output of the logic circuit, and sends the result to functional blocks, is provided; and thereby the falsification of the data of money and the program written in a nonvolatile memory can be prevented.

### BACKGROUND OF THE INVENTION

1. Field of the Invention

The present invention relates to a microcomputer for use in the system control of, for instance, an automatic toll collection system for toll roads and the like system.

2. Description of the Prior Art

FIG. 7 is a block diagram showing an example of the composition of a conventional microcomputer. FIG. 7 shows electrically erasable and reprogrammable nonvolatile memories 3 and 4, that is to say, a data EEPROM 3 for storing user data, and a program EEPROM 4 for storing user programs.

FIG. 7 also shows a serial-in-shift register 9, a mode-bit-decoding circuit 10, a central processing unit (CPU) 11, a mask ROM 12 for storing programs, a RAM 13 for temporarily storing programs, a timer 14, a UART 15 for data-communication with the outside via a serial I/O, a data bus 16, a clock-generating circuit 17 for frequency-dividing a master clock to a specified frequency-division rate, an oscillating circuit 18 for generating the master clock, a port 19 to be used for sending data to the outside and receiving data therefrom, a CNVSS terminal 21, a power terminal (Vcc) 23, a ground (GND) 24, reset terminal 25, and a port terminal (PORT) 26.

Functional blocks such as the above-mentioned internal memory, timer 14, UART 15, and the like are connected with the CPU 11 by way of the data bus 16. Each of the functional blocks is controlled by the CPU 11.

Moreover, the microcomputer includes a plurality of modes such as a single-chip mode that loads a program contained in the internal ROMs such as the program EEROM 4 and mask ROM 12 to be operated, and a microprocessor mode that loads a program from the external memory to be operated in which the port terminal 26 serves as an address bus or a data bus that connects with the external memory. On releasing of each reset, the potential of the CNVSS terminal 21 is latched to be branched to each mode.

For instance, on the release reset, 0 V of the potential of the CNVSS terminal 21 permits an entry to the single chip mode, and 5 V of the potential thereof permits an entry to the microprocessor mode. Alternatively, on the release reset, when (start bit+mode bit (5 bits)) are serially input from the CNVSS terminal 21, the input signals are latched by the serial-in-shift register 9, and then decoded by the mode-bit-decoding circuit 10, thereby executing also an entry to each mode depending on the decoded results.

Referring to FIG. 8, the operation of the mode entry of the serial input will be next described.

FIG. 8 is a timing chart in a mode entry in the conventional microcomputer. As shown in FIG. 8, a temporary mode is determined based on the input level of the CNVSS terminal 21 when the reset terminal 25 is 0 V. A latch is made during the rise time of the reset terminal 25, and the operation is executed provisionally in the operational or temporary mode. After the reset release, an entry into the wait state of the start bit is made after counting of 4 cycles in Xin. After that, detecting the start bit of “10b” begins serial receiving. After detecting the start bit, the data of 5 bits is serially received. The reception result is written in serial-in-shift register 9 in the next rise time of the clock.

It is noted that when the start bit is not detected, and the serial receiving is not completed by the 16th cycle, the temporary mode established at the time of the reset release is determined as a formal mode.

In this system, a mode bit of 5 bits in the serial-in-shift register 9 is decoded by the mode-bit-decoding circuit 10, thus determining each mode. For instance, when all the 5 bits are “0”, the single chip mode is determined; when all the 5 bits are “H”, the microprocessor mode is determined.

Since the conventional microcomputer is configured as mentioned above, though the mode entry by serial-in is not open to users, these modes include a mode which enables an access to the internal memories (data EEPROM 3, program EEPROM 4, and mask ROM 12) from an external terminal. Thus the problem arises that the data and program for an amount of money written in the data EEPROM 3 or program EEPROM 4 might be falsified.

### SUMMARY OF THE INVENTION

The present invention has been accomplished to solve the above-described problem, and an object of the present invention is to provide a microcomputer in which the falsification of the data and program written in the nonvolatile memory of data EEPROM, program EEPROM, and mask ROM, etc. can be prevented.

First, the present invention provides a microcomputer that has a reprogrammable nonvolatile memory in which a lock code is written in the specified area; and that comprises a first decoding circuit connected with the nonvolatile memory, which reads out the lock code, and decodes the code; a logic circuit that performs a predetermined operation on an externally input mode bit, by the output from the first decoding circuit; and a second decoding circuit that decodes the processed mode bit by receiving the output from the logic circuit, and sends the obtained result to the functional block.

In the microcomputer, the logic circuit may consist of an AND circuit.

Second, the present invention provides a microcomputer that has an internal memory comprising a reprogrammable nonvolatile memory, in which a map-selecting code for selecting a memory map is written in the specified area; and that comprises a first decoding circuit connected with the nonvolatile memory, which reads out the map-selecting code, and decodes the code; an address decoder that decodes by the predetermined bit of an address bus, and thereby outputs a chip-selecting signal; and a selector circuit that selects the memory map by receiving the output from the first decoding circuit and the output from the address decoder, and sends the result to the internal memory comprising the nonvolatile memory.

In the microcomputer, the internal memory may comprise a mask ROM.

Third, the present invention provides a microcomputer that has a reprogrammable nonvolatile memory, in which a function-selecting code for selecting the function of an external terminal is written in the specified area; and that comprises a first decoding circuit connected with the nonvolatile memory, which reads out the function-selecting code and decodes the code; and a selector circuit that selects the function of the external terminal by receiving the output from the first decoding circuit.

Fourth, the present invention provides a microcomputer that has a reprogrammable nonvolatile memory, in which a limiting code for limiting the command is written in the specified area; and that comprises a first decoding circuit connected with the nonvolatile memory, which reads out the limiting code, and decodes the code; and a second decoding circuit that limits the command to be used, by the output from the first decoding circuit.

Fifth, the present invention provides a microcomputer that has a reprogrammable nonvolatile memory; and that comprises a voltage-regulating circuit that monitors the power supply voltage; a logic circuit that performs a predetermined operation on an externally input mode bit by the output from the voltage-regulating circuit; and a decoding circuit that decodes the processed mode bit by receiving the output from the logic circuit, and sends the result to the functional block.

In addition, in the microcomputer, the reprogrammable nonvolatile memory may consist of a data memory and a program memory.

### BRIEF DESCRIPTION OF THE DRAWINGS

FIG. 1 is a block diagram showing the composition of a microcomputer according to Embodiment 1 of the present invention.

FIG. 2 is a view showing the mode-bit-decoding portion of a microcomputer according to Embodiment 1 of the present invention.

FIGS. 3A, 3B, and 3B each are a view showing the memory map of a microcomputer according to Embodiment 2 of the present invention.

FIG. 4 is a view showing the address-decoding portion of a microcomputer according to Embodiment 2 of the present invention.

FIG. 5 is a view showing the external terminal of a microcomputer according to Embodiment 3 of the present invention.

FIG. 6 is a block diagram showing the composition of a microcomputer according to Embodiment 5 of the present invention.

FIG. 7 is a block diagram showing an example of the composition of a conventional microcomputer.

FIG. 8 is a timing chart of mode entry in the conventional microcomputer.

### DETAILED DESCRIPTION OF THE PREFERRED EMBODIMENTS

An embodiment of the present invention will be described below.

Embodiment 1.

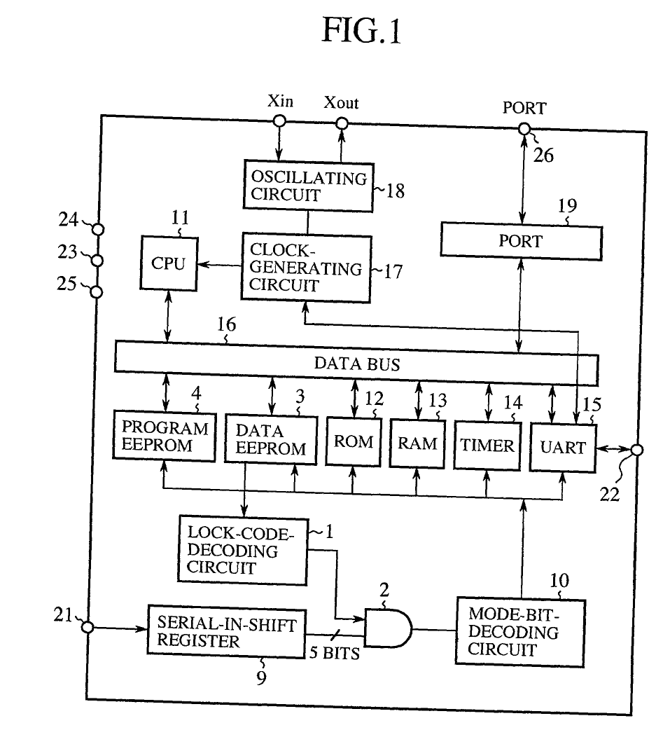

FIG. 1 is a block diagram showing the composition of a microcomputer according to Embodiment 1 of the present invention. Referring to FIG. 1, there are shown a lock-code-decoding circuit 1 (first decoding circuit), a logic circuit 2 (AND circuit), a data EEPROM 3 (reprogrammable nonvolatile memory, reprogrammable internal memory, or reprogrammable memory) for storing a user data, and a program EEPROM 4 (reprogrammable nonvolatile memory, reprogrammable internal memory, or reprogrammable memory) for storing a user program, the data EEPROM 3 and program EEPROM 4 constituting electrically erasable and reprogrammable nonvolatile memories.

FIG. 1 also shows a serial-in-shift register 9, a mode-bit-decoding circuit 10 (second decoding circuit), a CPU 11, a mask ROM 12 (internal memory or memory) for storing a program or the like, a RAM 13 (memory) for temporarily storing data, a timer 14, a UART 15 for data-communication with the external via a serial I/O, a data bus 16, a clock-generating circuit 17 for frequency-dividing a master clock to a specified frequency-division rate, an oscillating circuit 18 for generating the master clock, a port 19 to be used for sending data to the external and receiving data therefrom, a CNVSS terminal 21, a power terminal (Vcc) 23, a ground (GND) 24, a reset terminal 25, and a port terminal (PORT) 26.

Functional blocks such as the internal memory, timer 14, and UART 15 are connected with the central processing circuit 11 by way of the data bus 16. Each functional block is controlled by the central processing circuit 11.

Such a microcomputer includes a plurality of modes, for example, a single-chip mode that loads a program of the internal ROM to be operated, and a microprocessor mode that loads a program from the external memory to be operated with the port terminal 26 serving as an address bus or a data bus that connects with the external memory. When releasing each reset, the potential of the CNVSS terminal 21 is latched to be branched to each mode. Refer to the description of the aforementioned prior art for the specific example of the mode.

The microcomputer according to Embodiment 1 of the present invention has a feature which has the lock-code-decoding circuit 1 and the logic circuit 2 (AND circuit), which masks the mode bit of the serial-in-shift register 9 by the output of the lock-code-decoding circuit 1.

The operation will be next described.

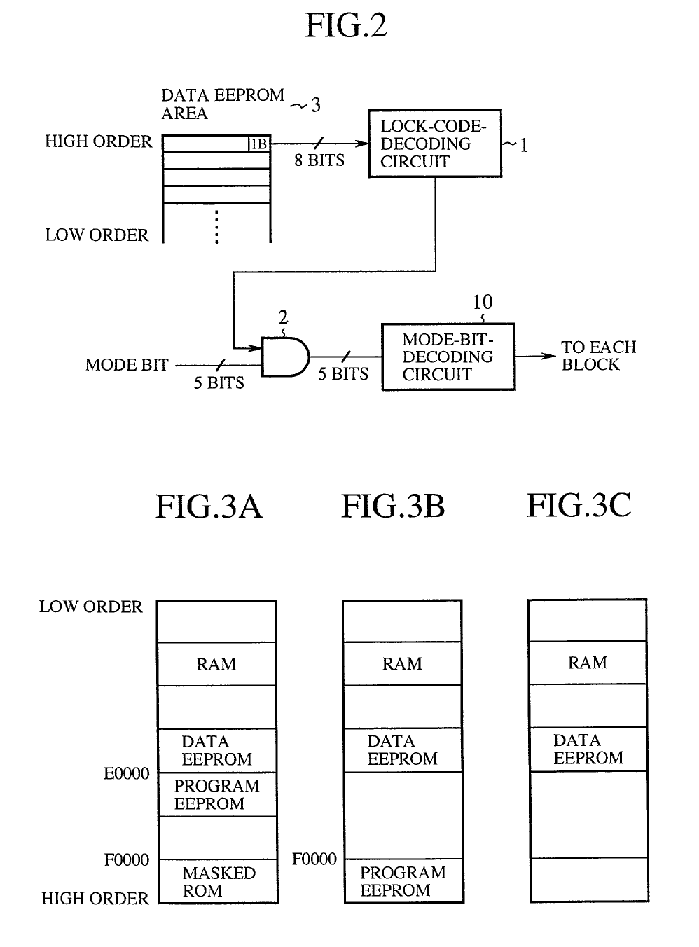

The microcomputer is adapted so that when a lock code is written, for instance, 8Dh in hexadecimal in a certain specified area one byte (for instance, one byte of the uppermost byte) in the data EEPROM 3, the system is prohibited from operating out of the mode specified by the lock code, irrespective of the entered mode. The operation will next be described in detail with reference to FIG. 2.

FIG. 2 is a view showing the mode-bit-decoding portion of a microcomputer according to Embodiment 1 of the present invention. When decoding 5 bits of the mode bit, the logic circuit 2 (AND circuit) is provided just before mode-bit-decoding circuit 10. This logic circuit 2 is a circuit which enables to mask 5 bits of the mode bit based on the output from the lock-code-decoding circuit 1.

A lock code, for instance, 8Dh is written in the uppermost one byte of the data EEPROM 3. This 8Dh is assumed to be a lock code prohibiting any mode other than the single chip mode. After releasing reset, the one byte of the data EEPROM 3 is read out and is decoded by the lock-code-decoding circuit 1. As a result, if 8Dh has been written, because the modes other than the single chip mode are prohibited, “L” level is output from the lock-code-decoding circuit 1.

On the other hand, when “L” level is input from lock-code-decoding circuit 1, since the output of the logic circuit 2 is compulsorily fixed to “L” level, the input of the mode-bit-decoding circuit 10 will be fixed. Accordingly, the mode will be fixed to the stated single chip mode.

That is, even if 5 bits of the mode bit each are determined to each value by serial input, writing the lock code in the uppermost one byte of the data EEPROM 3 may fix the operating mode.

As mentioned above, according to Embodiment 1, writing the lock code in the data EEPROM 3 before shipping the microcomputer makes it impossible for users to arbitrarily access an entry to any mode. The risk of access, from the external terminal, to the data written in the internal memory, e.g. the financial data or program written in data EEPROM 3 or program EEPROM 4 maybe eliminated, there by preventing the falsification of the financial data and the program, resulting in an improved security.

Embodiment 2.

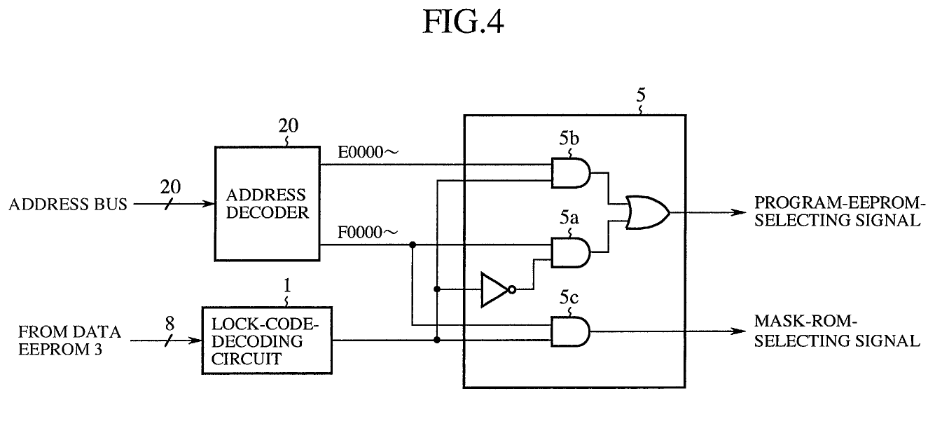

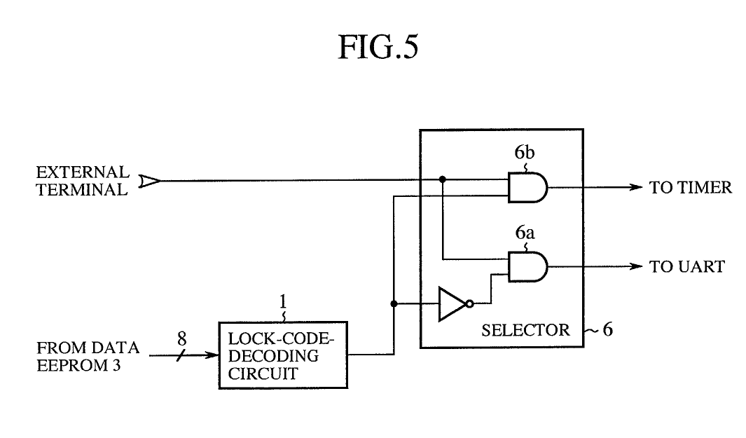

FIGS. 3A, 3B, and 3B each illustrate a memory map of the microcomputer of Embodiment 2 of the present invention, and FIG. 4 illustrates an address-decoding section thereof. FIG. 4 shows a selector circuit 5, AND circuits 5a, 5b, and 5c, and an address decoder 20.

The microcomputer according to Embodiment 2 has a feature with the selector circuit 5 so that one memory room can be selected from two memory rooms based on the output of the lock-code-decoding circuit 1. The lock-decoding circuit 1 is an equivalent to that described in Embodiment 1.

The operation of the microcomputer will be next described.

The system enables to select either of the memory map (A) and (B) as shown in FIGS. 3A and 3B by writing a memory-map-selecting code in a certain specified area, i.e. one byte (for instance, one byte of (the uppermost—1) byte) in the data EEPROM 3. Such an operation will be next described in detail with reference to FIG. 4.

The address decoder 20 decodes by use of 20 bits of the address bus, and thereby outputs a chip-selecting signal of “L” level at E0000h-EFFFFh and a chip-selecting signal of “L” level at F0000h-FFFFFh. Needless to say, there are also chip selecting signals that become “L” level in the other area, for example in a RAM area of 400h-1FFFh.

A memory-map-selecting code, for example, E0h, when the memory map (A) of FIG. 3A is selected, is written to one byte (the uppermost—1) of the data EEPROM 3, and when the memory map (B) of FIG. 3B is selected, a code other than E0h is written. Assume that E0h is here written.

After releasing reset, one byte of the data EEPROM 3 is read out, and is decoded by the lock-code-decoding circuit 1. As a result, because E0h has been written, the lock-code-decoding circuit 1 outputs “H” level. When the lock-code-decoding circuit 1 outputs “H” level, the output of the AND circuit 5a of the selector 5 is fixed to “L” level, and a chip-selecting signal of E0000h-EFFFFh is connected with the selecting signal of the program EEPROM 4. A chip-selecting signal of F0000h-FFFFFh is connected with the selecting signal of the mask ROM 12. As a result, each memory is mapped as shown in the memory map (A) of FIG. 3A.

Similarly, when a code other than E0h is written in one byte (the uppermost—1) of the data EEPROM 3, “L” level is output from the lock-code-decoding circuit 1. This time the output of the AND circuit 5b is fixed to “L” level, and the output of the AND circuit 5c is also fixed. As a result, each memory is mapped as shown in the memory map (B) of FIG. 3B.

As mentioned above, according to Embodiment 2, a test program is previously written, for instance, in the mask ROM 12, and in the test, the system is booted from the mask ROM 12 to carry out the test. Upon shipping the microcomputer, writing the memory-map-selecting code enables the mask ROM 12 to be invisible to users, thereby maintaining the security of the test contents. Moreover, there is an advantage that, if there exists a bag in the program of the mask ROM 12, the program can be replaced with the program written in the program EEPROM 4.

In addition, in combination with the circuitry of Embodiment 1, fixing the microprocessor mode to a memory map (C) of FIG. 3C puts the lid on the falsification in the program area.

Embodiment 3.

FIG. 5 is a view showing the external terminal of a microcomputer according to Embodiment 3 of the present invention. FIG. 5 shows a lock-code-decoding circuit 1, a selector circuit 6, and AND circuits 6a and 6b. The other components are similar to the above-mentioned Embodiment 1, and the description will be therefor omitted.

The microcomputer according to Embodiment 3 has a feature with the selector circuit 6 in addition to the circuit configuration described in the above-described Embodiment 1 so that a function of an external terminal can be selected based on the output of the lock-code-decoding circuit 1.

The system was contrived such that writing a certain code, for instance, C0h in a certain specified area, i.e. one byte (for instance, one byte of the uppermost—2) in the data EEPROM 3 allows a selection of the function of the external terminal. For instance, in the case where a certain external input terminal is commonly used for inputting the signal of a timer when testing and for inputting the input signal of the UART 15 when used as the product, writing the code C0h disables the function of inputting the signal when testing.

The operation will next be described.

Referring to FIG. 5, C0h is first written in one byte (one byte of the uppermost byte—2) of the data EEPROM 3. After releasing reset, the one byte of the data EEPROM 3 is read out, and is decoded by the lock-code-decoding circuit 1. As a result, when C0h is written therein, the lock-code-decoding circuit 1 outputs “H” level. With the lock-code-decoding circuit 1 outputting “H” level, the output of the AND circuit 6a of the selector circuit 6 is thereby fixed to “L” level; the input to the UART 15 is thereby fixed to “L” level; and the external terminal serves as an input terminal for the timer.

Similarly, when a code other than C0h is written in one byte (the uppermost byte—2) of the data EEPROM 3, “L” level is output from the lock-code-decoding circuit 1, and the output of the AND circuit 6b is thereby fixed to “L” level. As a result, the external terminal serves as an input terminal for the UART 15.

As mentioned above, according to this embodiment, writing a certain code in one byte of the area of the data EEPROM 3 may limit the function of the external terminal.

Embodiment 4.

According to Embodiment 4 of the present invention, there is a feature that, for instance, in the circuit configuration of the above-described Embodiment 1, writing a certain code, for example, B0h in the specified one byte (for instance, one byte of the uppermost—3) of the area of data EEPROM 3, limits available commands.

For instance, a command concerning the program EEPROM 4 storing programs, a write command, and an erase command are made inoperable by writing this code B0h upon shipping. This may prevent false writings and intentional reprogrammings by users.

Embodiment 5.

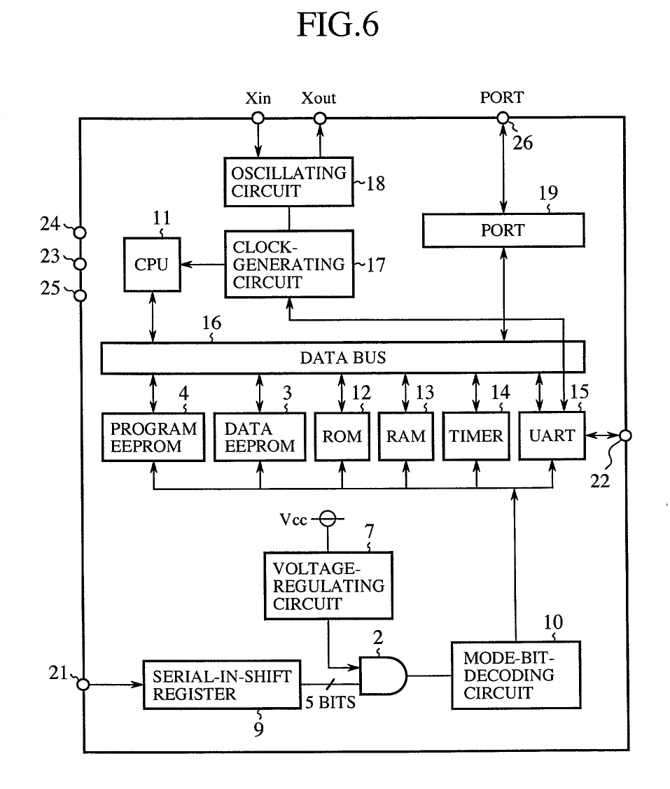

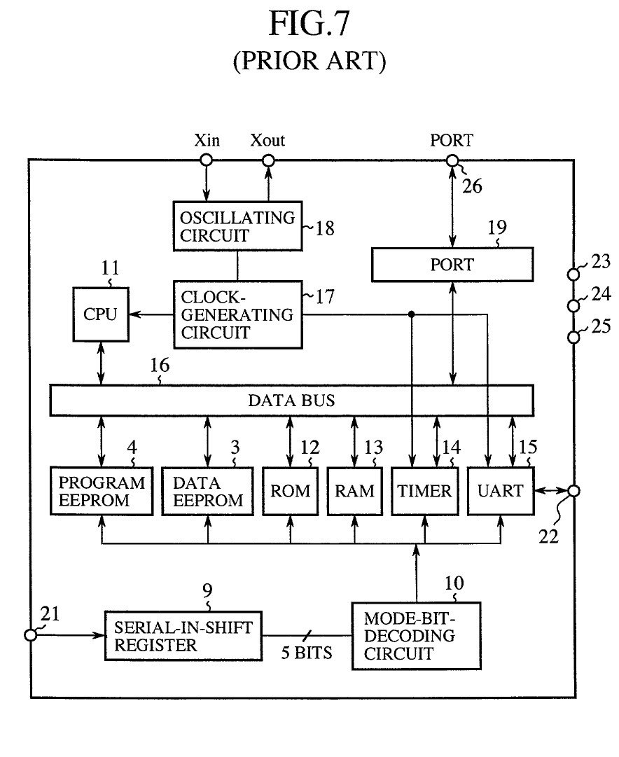

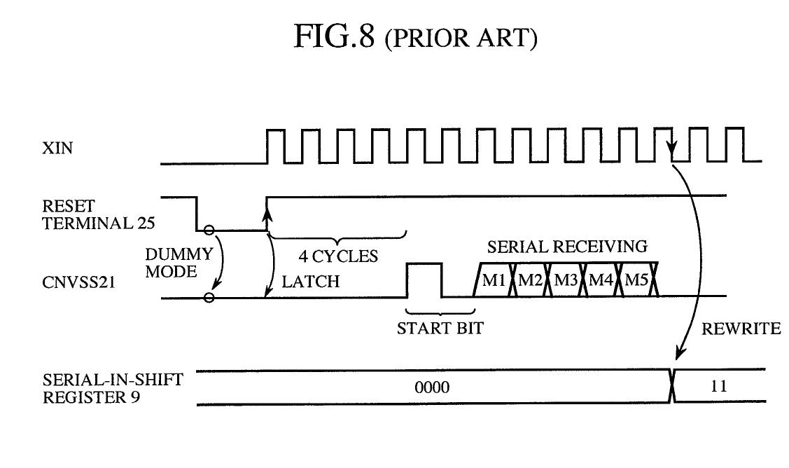

FIG. 6 is a block diagram showing the composition of the microcomputer of Embodiment 5 of the present invention. In the figure are shown the voltage-regulating circuit 7 and logic circuit (AND circuit) 8. The other components are similar to those of the prior art as shown in FIG. 7, the descriptions will be omitted.

Embodiment 5 of the present invention has a feature with the voltage-regulating circuit 7 for monitoring the power supply voltage (Vcc), and the logic circuit 8 for masking the mode bit of the serial-in-shift register 9 by the output thereof.

The voltage-regulating circuit 7 monitors the power-supply voltage, and the circuit 7 is contrived to output “L” level when the power-supply voltage is insufficient (for instance, 3 V or less). Upon decoding 5 bits of the mode bit, the logic circuit 8 is provided just before the mode-bit-decoding circuit 10, and the logic circuit 8 is contrived to mask the 5 bits of the mode bit by the output from the voltage-regulating circuit 7.

The operation will next be described.

When the circuit of the microcomputer is made to operate by a low voltage, for instance, 3 V or less, the voltage-regulating circuit 7 outputs “L” level. Since the output from the logic circuit 8 is compulsorily fixed to “L” level when “L” level is input to the logic circuit 8 from the voltage-regulating circuit 7, the input of the mode-bit-decoding circuit 10 will be thereby fixed. Accordingly, when the circuit is made to operate by a low voltage, 3 V or less, the circuit will be fixed to a certain mode.

As mentioned above, in the above-mentioned embodiments 1-4, even if a certain lock code in the data EEPROM 3 has been written, in the case the power-supply voltage (Vcc) is insufficient, and thereby the action of reading out of the relevant EEPROM 3 becomes unstable, there is a possibility that the read data is garbled. In that case, the lock code cannot be normally decoded, and some times the mode is not locked. However, according to Embodiment 5, because, if the power-supply voltage is within the unstable region, the mode can be locked, the effect of preventing the above-described problem is produced.

The above-mentioned embodiment was described by using EEPROM as the readable nonvolatile memory. However, a flash memory or the other EPROM can be used instead of the EPROM.

As mentioned above, the present invention provides a microcomputer that has a reprogrammable nonvolatile memory in which a lock code is written in the specified area; and that comprises a first decoding circuit connected with the nonvolatile memory, which reads out the lock code, and decodes the code; a logic circuit that performs a predetermined operation on an externally input mode bit, by the output from the decoding circuit; and a second decoding circuit that decodes the processed mode bit by receiving the output from the logic circuit, and sends the obtained result to the functional block. Therefore, because the processed output from the concerned logic circuit can be fixed by the lock code previously written in the specified area of a reprogrammable nonvolatile memory, by using, for example, an AND circuit for the logic circuit, the operation mode of the microcomputer can be limited. The present invention has thereby the effects of preventing the falsification of the data and the program contained in the reprogrammable nonvolatile memory, and of increasing the security.

According to the present invention, the logic circuit consists of an AND circuit. Therefore, the output from the concerned logic circuit can be fixed, and as mentioned above, the operation mode of the microcomputer can be limited. The present invention has thereby the effects of preventing the falsification of the data and the program contained in the reprogrammable nonvolatile memory, and of increasing the security.

The present invention provides a microcomputer that has an internal memory comprising a reprogrammable nonvolatile memory, in which a map-selecting code for selecting a memory map is written in the specified area; and that comprises a first decoding circuit connected with the nonvolatile memory, which reads out the map-selecting code, and decodes the code; an address decoder that decodes the predetermined bit of an address bus, and thereby outputs a chip-selecting signal; and a selector circuit that selects the memory map by receiving the output from the first decoding circuit and the output from the address decoder, and sends the result to the internal memory comprising the nonvolatile memory. Therefore, the selector circuit can select and isolate the memory map by the map-selecting code previously written in the specified area of the reprogrammable nonvolatile memory; and can thereby make the test program in the internal memory to be invisible to the user. The present invention has the effect of maintaining the security of the test content.

According to the present invention, the internal memory consists of a mask ROM. Therefore, the test program is previously written in the mask ROM, and this is used in the test. However, upon shipping the microcomputer, the mask ROM can be made to be invisible by the map-selecting code. The present invention has thereby the effect of maintaining the security of the test content.

The present invention provides a microcomputer that has a reprogrammable nonvolatile memory, in which a function-selecting code for selecting the function of an external terminal is written in the specified area; and that comprises a first decoding circuit connected with the nonvolatile memory, which reads out the function-selecting code and decodes the code; and a selector circuit that selects the function of the external terminal by receiving the output from the first decoding circuit. Therefore, the selector circuit can limit the functions of the external terminal by the function-selecting code previously written in the specified area of the reprogrammable nonvolatile memory, and can make, for instance, the function of the input terminal in the test, inoperable. The present invention has thereby the effect of maintaining the security of the test content.

The present invention provides a microcomputer that has a reprogrammable nonvolatile memory, in which a limiting code for limiting the command is written in the specified area; and that comprises a first decoding circuit connected with the nonvolatile memory, which reads out the limiting code, and decodes the code; and a second decoding circuit that limits the command to be used, by the output from the first decoding circuit. Therefore, the command to be used can be limited by the limiting code previously written in the specified area of the reprogrammable nonvolatile memory. The present invention has thereby the effects of preventing wrongly writing and intentional rewriting by users, and of maintaining the security.

The present invention provides a microcomputer that has a reprogrammable nonvolatile memory; and that comprises a voltage-regulating circuit that monitors the power supply voltage; a logic circuit that performs predetermined operation on an externally input mode bit by the output from the voltage-regulating circuit; and a decoding circuit that decodes the processed mode bit by receiving the output from the logic circuit, and sends the result to the functional block. Therefore, because, if the power supply voltage is in the unstable operating region, the voltage-regulating circuit locks the mode, even in the case the reading action of the reprogrammable nonvolatile memory is unstable, the operating mode of the microcomputer can be fixed with reliability. The present invention has thereby the effects of preventing the falsification of the data and the program contained in the reprogrammable nonvolatile memory, and of increasing the security.

According to the present invention, the reprogrammable nonvolatile memory consists of a data memory and a program memory. Therefore, the present invention has the effect of preventing the above-described falsification and tampering, and of maintaining the security by previously writing the lock code, the map-selecting code, the function-selecting code, and the limiting code in the data memory.

What is claimed is:

1. A microcomputer comprising a memory, a central processing unit, and a functional block comprising a peripheral block, built-in said microcomputer, wherein said memory has a reprogrammable nonvolatile memory, in which a lock code is written in a specified area; and the microcomputer comprises:
a first decoding circuit connected with said nonvolatile memory, which reads out said lock code, and decodes said lock code;
a logic circuit that performs a predetermined operation on an externally input mode bit, by the output from the first decoding circuit; and
a second decoding circuit that decodes the processed mode bit by receiving the output from said logic circuit, and sends the obtained results to said functional block.

2. The microcomputer of claim 1, wherein said logic circuit consists of an AND circuit.

3. A microcomputer comprising a memory, a central processing unit, and a functional block comprising a peripheral block, built-in said microcomputer, wherein said memory has an internal memory comprising a reprogrammable nonvolatile memory, in which a map-selecting code for selecting a memory map is written in a specified area, and
said microcomputer comprises:
a first decoding circuit connected with said nonvolatile memory, which reads out said map-selecting code, and decodes this code;
an address decoder that decodes by a predetermined bit of an address bus, and thereby outputs a chip-selecting signal; and
a selector circuit that selects said memory map by receiving the output from said first decoding circuit and the output from said address decoder, and sends the results to said internal memory comprising said nonvolatile memory.

4. The microcomputer of claim 3, wherein said internal memory comprises a mask ROM.

5. A microcomputer comprising a memory, a central processing unit, a functional block comprising a peripheral block, built-in said microcomputer, and an external terminal, wherein said memory comprises a reprogrammable nonvolatile memory, in which a function-selecting code for selecting the function of the external terminal is written in a specified area; and
said microcomputer comprises:
a first decoding circuit connected with the nonvolatile memory, which reads out said function-selecting code and decodes this code; and
a selector circuit that selects a function of the external terminal by receiving the output from said first decoding circuit.

6. A microcomputer comprising a memory, a central processing unit, and a functional block comprising a peripheral block, built-in said microcomputer, wherein said memory comprises a reprogrammable nonvolatile memory, in which a limiting code for limiting a command is written in a specified area; and
said microcomputer comprises:
a first decoding circuit connected with said nonvolatile memory, which reads out said limiting code, and decodes this code; and
a second decoding circuit that limits a command to be used, by the output from said first decoding circuit.

7. A microcomputer comprising a memory, a central processing unit, and a functional block comprising a peripheral block, built-in said microcomputer, wherein said memory comprises a reprogrammable nonvolatile memory; and
said microcomputer comprises:
a voltage-regulating circuit that monitors a power supply voltage;
a logic circuit that performs a predetermined operation on an externally input mode bit by the output from said voltage-regulating circuit; and
a decoding circuit that decodes the processed mode bit by receiving the output from said logic circuit, and sends the results to said functional block.

8. The microcomputer of claim 1, wherein said reprogrammable nonvolatile memory consists of a data memory and a program memory.
